(19) United States
(12) Patent Application Publication
(10) Pub. No.: US 2007/0151582 A1
(43) Pub. Date: Jul. 5, 2007

(54) Supercritical fluid washing method and system

(75) Inventors: Kon-Tsu Kin, Chu-Tung (TW); Chiou-Mei Chen, Chu-Tung (TW); Pei-Lin Chang, Chu-Tung (TW); Yi-Ching Chen, Chu-Tung (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu (TW)

(21) Appl. No.: 11/634,846

(22) Filed: Dec. 7, 2006

(30) Foreign Application Priority Data
Dec. 9, 2005 (TW) 94143484

(51) Int. Cl. B08B 7/04; B08B 3/00

(52) U.S. Cl. 134/26; 134/94.1; 134/109; 134/10

(57) ABSTRACT

A supercritical fluid washing method and system in which a supercritical fluid washing system employs a supercritical fluid to clean the surface of materials possessing surface microstructures, and where a supercritical fluid is used to soak, wash, and dry elements; the element surface may include nanometer pores or high aspect ratio microstructures. This supercritical fluid washing method is able to remove impurities or water vapor from the surface of elements.

### BACKGROUND OF THE INVENTION

1. Field of the Invention

The present invention relates to an element washing method and system. More particularly, the invention relates to a supercritical fluid washing method and system.

2. Description of the Related Art

Responding to future product needs, element design is generally evolving in the direction of greater precision, greater complexity, and higher density. As a consequence, microstructure element dimensions have been reduced to micron, submicron, and increasingly nanometer size. Because microstructure materials contain many tiny surface structures, such as nanometer grooves and pores, and material that enters such nanometer grooves and pores will be difficult to remove. Impurities on the surface of microstructure materials commonly cause the element's electrical properties to change, or cause defects in surface characteristics. As a consequence, a washing step to remove foreign matter from the surface is needed in the element manufacturing process. Conventional washing methods require the use of large amounts of strongly oxidizing solvents, organic solvents, or acidic/alkaline solvents to wash elements. Although these methods are effective to some degree, they produce large quantities of wastewater and waste acidic/alkaline liquids, readily cause product contamination and environmental pollution, and increase process wastewater treatment costs.

Furthermore, when an element has a porous microstructure, the strong surface tension of most solvents can prevent the solvent from entering the microstructure and removing foreign matter. This often results in a residue. Elements also require a subsequent drying step. The drying process may damage the element's microstructure, however, and cause characteristics to deteriorate.

These considerations have motivated the use of supercritical fluids (SCFs) in the element washing process. As is disclosed in U.S. Pat. No. 6,306,754, a supercritical fluid is used to remove photoresist residue through pores remaining after etching. The supercritical fluid possesses special characteristics such as low surface tension and high diffusivity; it can wet and permeate all the fine features of a microstructure, porous material, or parts or components with complex structures. Furthermore, a supercritical fluid can be blown out using high-pressure gas after dissolving a fluid with low volatility, achieving the goal of washing. Supercritical fluids can be used to remove and clean solvents such as solder flux and photoresist. Supercritical fluids possess the advantages of being non-toxic, not needing to dry, not requiring wastewater/waste liquid treatment and conserving energy. The etching of today's porous low dielectric constant film substrates tends to cause deterioration of the film material, and water vapor adsorbed in residual pores will cause the dielectric constant to rise. As a result, the problem of the simultaneous existence of water vapor and organic contaminants should not be neglected. How to use a supercritical fluid to effectively wash elements, remove organic contaminants and water vapor, achieve the goals of surface activation and modification, and improve product good rate and reliability is currently considered a very important goals.

### SUMMARY OF THE INVENTION

The chief goal of the present invention is to provide a supercritical fluid washing method and system they can be used to remove surface impurities from an element and improve surface characteristics.

The supercritical fluid washing method disclosed in the present invention can be used to remove impurities from the surface of an element placed in a treatment chamber. Steps include introducing the first supercritical fluid into the treatment chamber to clean the element surface; discharging the first supercritical fluid; introducing the second supercritical fluid into the treatment chamber to soak the element; causing the second supercritical fluid to circulate and rinse the element; and, finally, drying the element. The surface of the element may include nanometer pores or high aspect ratio microstructures. The supercritical fluid can wash out impurities and water vapor lodged in the nanometer pores or microstructures, and remove them from the element.

In the embodiments of the present invention, the first supercritical fluid may include a modifier to strengthen the cleaning effect. The modifier may be added in an amount so as to constitute from 0.5% to 15% of the mixture by volume. Modifiers may include methanol, ethanol, propyl alcohol, and butyl alcohol.

In the embodiments of the present invention, The first supercritical fluid may have a temperature ranging from 40° C. to 80° C., and a pressure ranging from 1,000 psi to 5,000 psi.

In the embodiments of the present invention, the second supercritical fluid used to soak and rinse elements may have a temperature ranging from 40° C. to 80° C., and a pressure ranging from 1,000 psi to 5,000 psi.

In conjunction with the foregoing methods, the present invention's supercritical fluid washing system shall include a supercritical fluid source, a modifier supply, a recirculation loop, and a treatment chamber. The treatment chamber can be filled with and discharge the supercritical fluid. The supercritical fluid source is connected with the treatment chamber, and can supply the supercritical liquid to the treatment chamber. The modifier supply is connected with the treatment chamber, and can supply modifier to the treatment chamber. Recirculation loop possesses an inlet and an outlet; the inlet and outlet are separately connected with the treatment chamber. Supercritical fluid leaves the treatment chamber via the recirculation loop's outlet, and enters the treatment chamber via the recirculation loop's inlet. The recirculation loop ensures that the supercritical fluid in the treatment chamber is in a state of circulating flow.

In the embodiments of the present invention, the treatment chamber may include an element mounting device used to hold elements in a vertical or horizontal position for washing. The element mounting device may be able to move in rotating or rocking fashion in order to increase the effectiveness of washing.

In the embodiments of the present invention, an included discharge fluid recycling device is connected with the treatment chamber and recycles the discharged supercritical fluid and returns it to the fluid source. The discharge fluid recycling device may include a filter serving to remove foreign matter from the discharged supercritical fluid.

In the embodiments of the present invention, an included flow control device is connected with the supercritical fluid source and treatment chamber, and is used to control the flow of supercritical fluid into the treatment chamber.

In the embodiments of the present invention, an included pressure control device is used to control the pressure of the supercritical fluid entering the treatment chamber. In addition, a temperature control device controls the temperature of the supercritical fluid entering the treatment chamber.

The foregoing method can be used to wash elements without destroying the existing structure and characteristics of the material. This method provides the dual effects of cleaning and modification, and offers the advantages of high efficiency and environmental safety. A supercritical fluid can deeply penetrate an element's surface microstructure, and remove foreign matter including impurities and water vapor without destroying the microstructure. Furthermore, since most known supercritical fluids are gaseous at ambient pressure, they can be vaporized by reducing the pressure. Because supercritical fluids can be separated from other solid and liquid materials in this manner, they are easy to recycle and reuse.

The following detailed description of the present invention will aid further understanding of its goals, characteristics, and functions:

### BRIEF DESCRIPTION OF THE DRAWINGS

FIG. 1 is a process flowchart of the preferred embodiment of the present invention.

FIG. 2 is a schematic diagram of the preferred embodiment of the present invention.

FIG. 3 is a plot of the operating electric field against the current density in the carbon nanotubule LEDs.

### DETAILED DESCRIPTION OF THE INVENTION

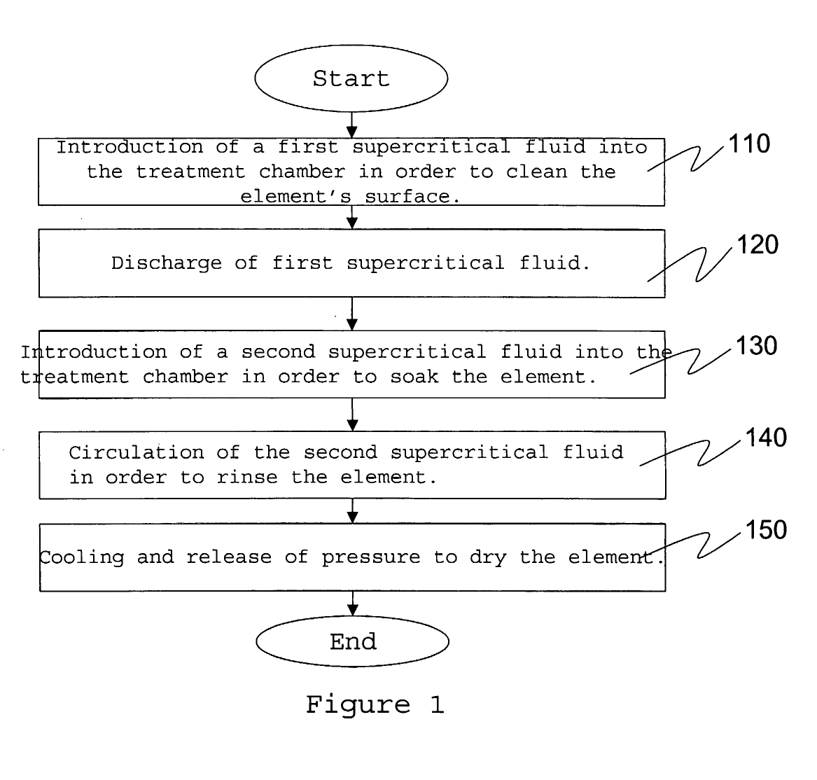

The present invention relates to a supercritical fluid washing method. Please refer to FIG. 1, is a process flowchart of the preferred embodiment of the present invention. The supercritical fluid washing method can be used to remove impurities from the surface of elements placed in a treatment chamber. Steps include introducing the first supercritical fluid into the treatment chamber to clean the element surface (step 110); discharging the first supercritical fluid (step 120); introducing the second supercritical fluid into the treatment chamber to soak the element (step 130); causing the second supercritical fluid to circulate and rinse the element (step 140); and, finally, cooling and release of pressure to dry the element (step 150). Prior to drying the element, circulation of the second supercritical fluid may be stopped, and the element soaked for a period of time before restarting circulation and rinsing. Repeating the steps of soaking and rinsing the element with the second supercritical fluid one or more times will ensure is that the element surface is thoroughly cleaned.

When supercritical fluid is used for surface cleaning, the supercritical fluid may have a temperature ranging from 40° C. to 80° C., and a pressure ranging from 1,000 psi to 5,000 psi. The length of time during which the supercritical fluid is in contact with the material surface may range from 1 minute to 50 minutes depending on the circumstances. The supercritical fluid may consist of an inert gas such as carbon dioxide. Carbon dioxide becomes hydrophobic and can dissolve organic matter when in a supercritical state. The supercritical fluid shall also include a modifier constituting from 0.5% to 15% of the mixture by volume. The modifier may be an alkene, alcohol, ketone, DMSO, or any mixture thereof. In general, methanol, ethanol, propyl alcohol, and butyl alcohol may be used as modifiers.

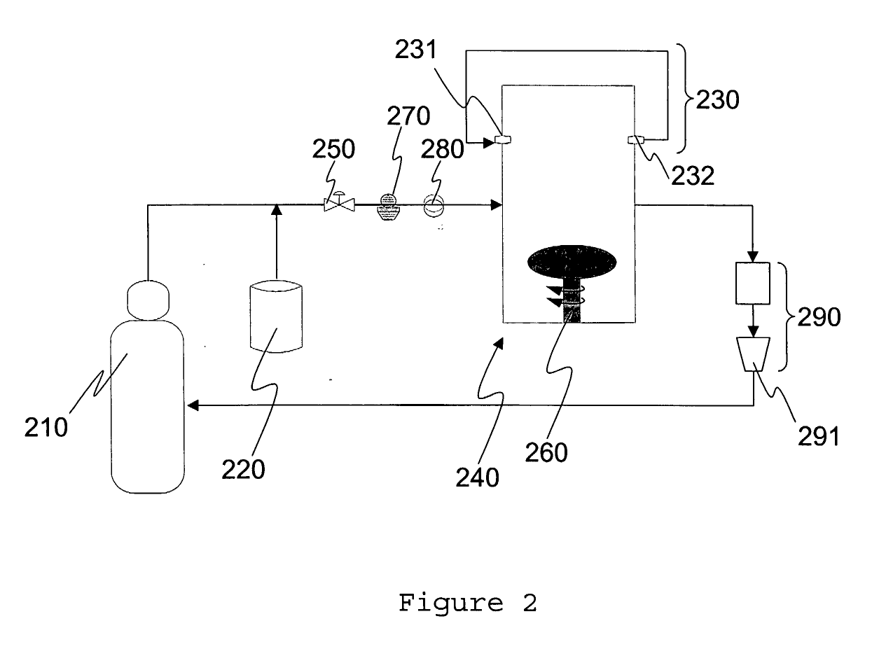

In conjunction with the foregoing method, the present invention consists of a supercritical fluid washing system. Please refer to FIG. 2 for a schematic diagram of the preferred embodiment of the present invention. This diagram shows the supercritical fluid source 210, modifier supply 220, recirculation loop 230, treatment chamber 240, flow control device 250, element mounting device 260, pressure control device 270, temperature control device 280, and discharge fluid recycling device 290. The supercritical fluid source 210 is connected with treatment chamber 240, and provides supercritical fluid to the treatment chamber. Modifier supply 220 is connected with treatment chamber 240, and provides modifier to treatment chamber 240. The recirculation loop 230 possesses an outlet 231 and inlet 232. The inlet 231 and outlet 232 are separately connected with treatment chamber 240; supercritical fluid leaves treatment chamber 240 via outlet 232 of the recirculation loop 230, and reenters treatment chamber 240 via inlet 231 of the recirculation loop 230. Recirculation loop 230 ensures that supercritical fluid circulates through treatment chamber 240.

Furthermore, discharge fluid recycling device 290 is connected with treatment chamber 240, and recycles the discharged supercritical fluid and returns it to the fluid source 210. Flow control device 250 is connected with supercritical fluid source 210 and treatment chamber 240, and serves to control the flow of supercritical fluid into treatment chamber 240. Pressure control device 270 is used to control the pressure of supercritical fluid entering treatment chamber 240. Temperature control device 280 is used to control the temperature of supercritical fluid entering treatment chamber 240. Treatment chamber 240 includes element mounting device 241, which is used to mount elements in a horizontal manner for washing. The element mounting device may be able to move in rotating or rocking fashion in order to increase the effectiveness of washing. Discharge fluid recycling device 290 includes filter 291 so as to remove foreign matter from the discharged supercritical fluid.

The following controlled experiment and detailed description of operating processes can provide a clearer explanation of implementation of the present invention:

Carbon nanotubule LEDs were used as elements possessing surface microstructure and awaiting surface treatment. Carbon nanotubule LEDs were first soaked in water to simulate the contamination with acid, alkalis, and water vapor, etc. that frequently occurs during the carbon nanotubule LED pattern process. This contamination often causes electrical defects in an element. A test was performed to determine whether the supercritical fluid washing method disclosed in the present invention could improve the quality of carbon nanotubule LEDs. Supercritical fluid was used to clean the surfaces of the carbon nanotubule LEDs that had been soaked in water. Washing was performed in accordance with the processes of an embodiment of the present invention. The first supercritical fluid consisted of supercritical carbon dioxide with 5% volume propyl alcohol as a modifier. The first supercritical fluid was maintained at a temperature of 50° C. and a pressure of 3,000 psi. After washing for 5 minutes, the carbon nanotubule LEDs were soaked and rinsed several times with the second supercritical fluid.

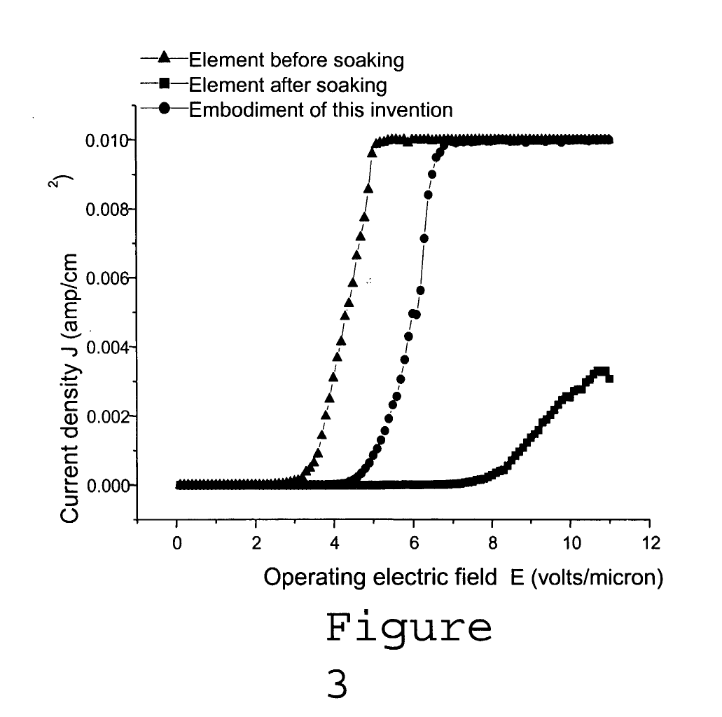

The final part of the test was to measure the electric field efficiency of the carbon nanotubule LEDs. The results are shown in FIG. 3, which plots the operating electric field against the current density in the carbon nanotubule LEDs. The x-axis plots the operating electric field and the y-axis plots the current density in the carbon nanotubule LEDs. The lower the electric field, the smaller the current. The steeper the current density curve, the easier it is to control the element. It can be seen from FIG. 3 that the electrical characteristics of the carbon nanotubule LEDs deteriorate after soaking in water. After supercritical fluid washing by means of an embodiment of the present invention, however, the electric field efficiency was restored to a considerable degree.

The preferred embodiments of the present invention described above are not intended to limit the present invention. Any person familiar with related art may make modifications and refinements that remain within the spirit and scope of the present invention. The scope of the claims of the present invention shall be determined by the claims attached to these specifications.

What is claimed is:

1. A supercritical fluid washing method, used to remove impurities from the surface of elements placed in a treatment chamber, comprising:
introducing a first supercritical fluid into the treatment chamber in order to clean the element surface;
discharging the first supercritical fluid;
introducing a second supercritical fluid into the treatment chamber in order to soak the element;
circulating the second supercritical fluid circulate in order to rinse the element; and
drying the element.

2. The supercritical fluid washing method of claim 1, wherein the first supercritical fluid includes a modifier, which is added in an amount so as to constitute from 0.5% to 15% of the mixture by volume.

3. The supercritical fluid washing method of claim 1, wherein the second supercritical fluid includes a modifier, which is added in an amount so as to constitute from 0.5% to 15% of the mixture by volume.

4. The supercritical fluid washing method of claim 2, wherein the modifier is methanol, ethanol, propyl alcohol, or butyl alcohol.

5. The supercritical fluid washing method of claim 3, wherein the modifier is methanol, ethanol, propyl alcohol, or butyl alcohol.

6. The supercritical fluid washing method of claim 1, wherein the element surface is feature nanometer pores or a high aspect ratio microstructure.

7. The supercritical fluid washing method of claim 1, wherein the first supercritical fluid have a temperature ranging from 40° C. to 80° C.

8. The supercritical fluid washing method of claim 1, wherein the second supercritical fluid have a soaked temperature ranging from 40° C. to 80° C.

9. The supercritical fluid washing method of claim 1, wherein the first supercritical fluid have a pressure ranging from 1,000 psi to 5,000 psi.

10. The supercritical fluid washing method of claim 1, wherein the second supercritical fluid have a pressure ranging from 1,000 psi to 5,000 psi.

11. The supercritical fluid washing method of claim 1, wherein the first supercritical fluid and the second supercritical fluid is a supercritical carbon dioxide fluid.

12. The supercritical fluid washing method of claim 1, wherein the following step is performed one or more times before drying the element:
Circulation of the second supercritical fluid is stopped and the element soaked for a period of time before circulation and rinsing.

13. A supercritical fluid washing system, comprising:
a treatment chamber, filled with and discharge a supercritical fluid;
a supercritical fluid source, connected with the treatment chamber and providing the supercritical fluid to the treatment chamber;
a modifier supply, connected with the treatment chamber and providing a modifier to the treatment chamber; and
a recirculation loop, possessing an outlet and an inlet, wherein the inlet and outlet are separately connected with the treatment chamber; the supercritical fluid leaves the treatment chamber via the outlet and re-enters the treatment chamber via the inlet

14. The supercritical fluid washing method of claim 13, wherein the treatment chamber includes an element mounting device used to hold the element to be washed.

15. The supercritical fluid washing method of claim 14, wherein the element mounting device enables the element to move in rotating or rocking fashion.

16. The supercritical fluid washing method of claim 13, further including a discharge fluid recycling device is connected with the treatment chamber and recycles the discharged supercritical fluid and returns it to the fluid source.

17. The supercritical fluid washing method of claim 13, wherein the discharge fluid recycling device includes a filter used to remove foreign matter from the supercritical fluid.

18. The supercritical fluid washing method of claim 13, further including a flow control device is connected with the supercritical fluid source and the treatment chamber, and is used to control the flow of supercritical fluid into the treatment chamber.

19. The supercritical fluid washing method of claim 13, further including a pressure control device is used to control the pressure of the supercritical fluid entering the treatment chamber.

20. The supercritical fluid washing method of claim 13, further including a temperature control device is used to control the temperature of the supercritical fluid entering the treatment chamber.
